(19) United States
(12) Patent Application Publication
(10) Pub. No.: US 2011/0316369 A1
(43) Pub. Date: Dec. 29, 2011

(54) ROTOR FAN FOR AN ELECTRIC MACHINE

(75) Inventors: Kirk Neet, Pendleton, IN (US); Scott Bitzer, Fishers, IN (US)

(73) Assignee: REMY TECHNOLOGIES, L.L.C., Pendleton, IN (US)

(21) Appl. No.: 12/824,704

(22) Filed: Jun. 28, 2010

(51) Int. Cl. H02K 9/06; H02K 15/02

(52) U.S. Cl. 310/62; 29/598

(57) ABSTRACT

An electric machine includes a rotor. The rotor includes a body having a number of pole members, a central hub, and a plurality of mounting members. The plurality of mounting members are fewer than half the number of pole members. A fan member is mounted to the rotor. The fan member includes a number of fan blades that project outward from a hub portion. A plurality of mounting elements are provided on select ones of the number of fan blades. The plurality of mounting members engage respective ones of the plurality of mounting elements to attach the fan member to the rotor.

### BACKGROUND OF THE INVENTION

Exemplary embodiments pertain to the art of electric machines and, more particularly, to a rotor fan for an electric machine.

Many electric machines include a stator and a rotor that are shifted relative to one another to create an electromotive force. In many cases, a fan is mounted relative to the rotor. In operation, the rotor spins the fan which, in turn, provides a cooling airflow to the electric machine. At present, the particular mounting of the fan to the rotor creates limitations on electric machine size. More specifically, mounting the fan to the rotor requires certain mounting structure on both components. As electric machines become smaller, pulleys and other components are mounted closer to the rotor. The particular structure required for mounting the fan limits the distance that the pulley or other such components can be mounted relative to the rotor.

### BRIEF DESCRIPTION OF THE INVENTION

Disclosed is an electric machine including a rotor. The rotor includes a body having a number of pole members, a central hub, and a plurality of mounting members. The plurality of mounting members are fewer than the number of half of the pole members. A fan member is mounted to the rotor. The fan member includes a number of fan blades that project outward from a hub portion. A plurality of mounting elements are provided on select ones of the number of fan blades. The plurality of mounting members engage respective ones of the plurality of mounting elements to attach the fan member to the rotor.

Also disclosed is an electric machine including a rotor having a body provided with a number of pole members and a central hub. The rotor includes a plurality of mounting members. A fan member is mounted to the rotor. The fan member includes a hub portion and a number of fan blades that project outwardly from the hub portion. The fan member includes a plurality of mounting elements provided on select ones of the number of fan blades. The number of fan blades include a first end portion and a second end portion. The first end portion defines a substantially planar surface and the second end portion is angled relative to the substantially planar surface. The plurality of mounting elements are formed in and are substantially coplanar with the substantially planar portion of the select ones of the number of fan blades. The plurality of mounting members engage respective ones of the plurality of mounting elements to attach the fan member to the rotor.

Also disclosed is a method of securing a fan member having a number of fan blades to a rotor of an electric machine. The rotor includes a number of poles that is distinct from the number of fan blades. The method includes positioning the fan member adjacent the rotor, aligning a plurality of mounting members provided on the rotor with a corresponding plurality of mounting elements provided on the fan member with the plurality of mounting members being fewer than half the number of poles, and securing the plurality of mounting members directly to substantially planar portions of the number of fan blades at the plurality of mounting elements.

### BRIEF DESCRIPTION OF THE DRAWINGS

The following descriptions should not be considered limiting in any way. With reference to the accompanying drawings, like elements are numbered alike:

FIG. 1 depicts an electric machine including a rotor and a fan member in accordance with an exemplary embodiment;

FIG. 2 is a perspective view of a rotor assembly of the electric machine of FIG. 1; and

FIG. 3 is a perspective view of the fan member of FIG. 1.

### DETAILED DESCRIPTION OF THE INVENTION

A detailed description of one or more embodiments of the disclosed apparatus and method are presented herein by way of exemplification and not limitation with reference to the Figures.

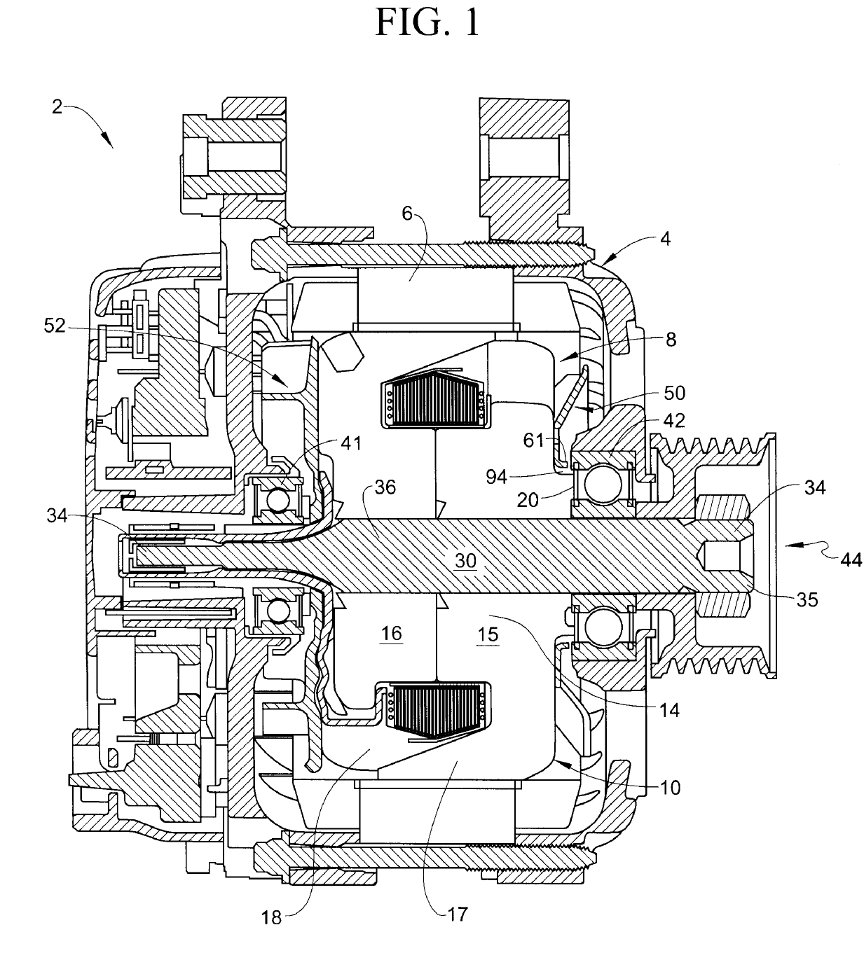

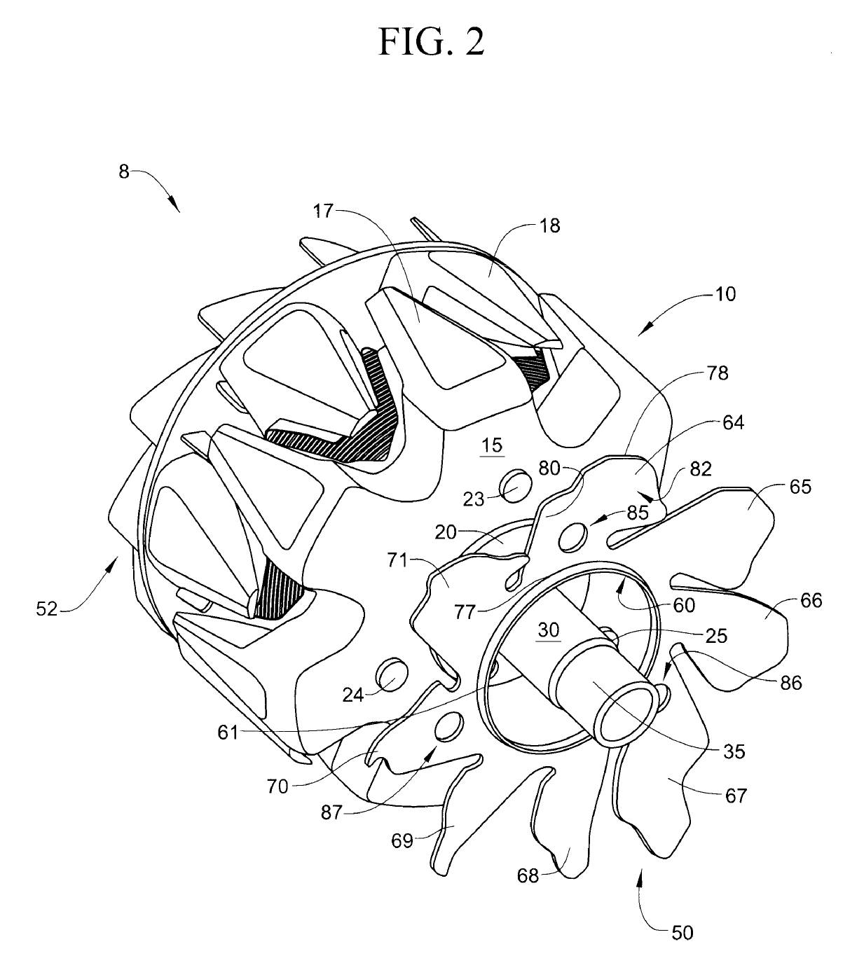

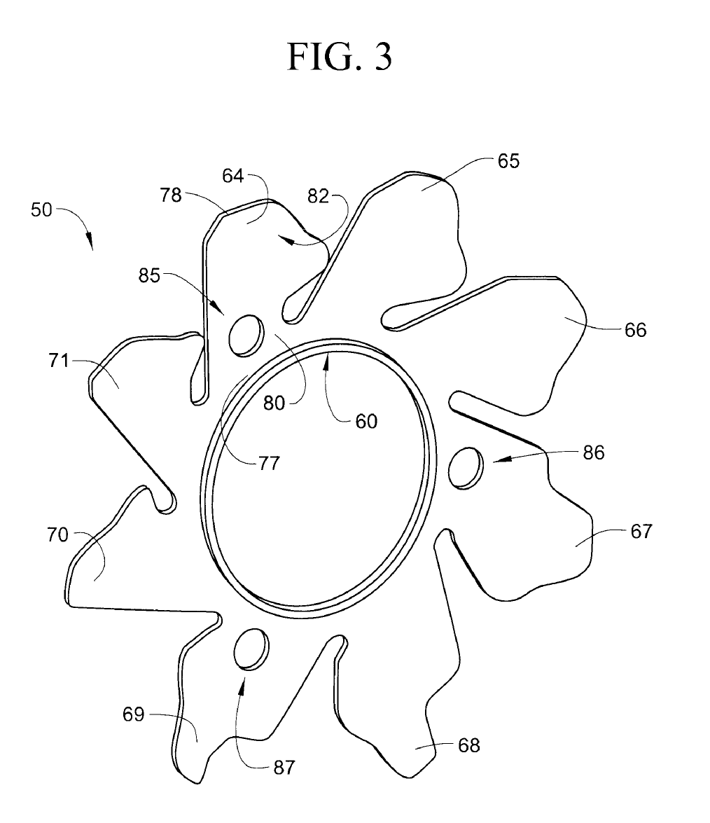

With reference to FIGS. 1-3, an electric machine, constructed in accordance with an exemplary embodiment, is indicated generally at 2. Electric machine 2 includes a housing 4 within which is arranged a stator 6 and a rotor assembly 8. Rotor assembly 8 rotates relative to stator 6 and includes a rotor 10 having a body 14. Body 14 includes a first half or portion 15 and a second half or portion 16. Each portion 15 and 16 includes a corresponding plurality of pole members, one of which is indicated at 17, on first portion 15 and at 18 on second portion 16. In the exemplary embodiment shown, the plurality of pole members 17 on first portion 15 represents half of a total number of pole members for rotor 10 and the plurality of pole members 18 on second portion 16 represents another half of the total number of pole members of rotor 10.

Rotor 10 includes a central hub 20 and a plurality of projections or mounting members 23-25 provided on first portion 15. As will become more fully evident below, mounting members 23-25 extend outward from body 14 and are arranged about central hub 20. Rotor 10 is also shown to include a shaft 30 that extends through first and second portions 15 and 16. Shaft 30 includes a first end 34 that extends to a second end 35 through an intermediate portion 36. Intermediate portion 36 is rotatably supported to housing 4 by first and second bearings 41 and 42. A sheave or pulley 44 is mounted to second end 35 of shaft 30. Pulley 44 is configured to drive or be driven by a belt (not shown). Rotor 10 is further shown to include a fan member 50 arranged adjacent first portion 15 and a fan component 52 arranged adjacent second portion 16. Fan member 50 and fan component 52 are configured to generate a cooling air flow through housing 4.

In accordance with an exemplary embodiment, fan member 50 includes a hub portion 60 having a raised circumferential lip or edge 61. Edge 61 provides enhanced strength that enables fan member 50 to withstand centrifugal forces associated with operation of electric machine 2. A plurality of fan blades 64-71 extend radially outward from hub portion 60. In accordance with the exemplary embodiment, the number of fan blades 64-71 is distinct from the number of pole members 17 on first portion 15. In the present exemplary embodiment, the number of fan blades 64-71 is greater than the number of pole members 17 on first portion 15. With this arrangement, fan blades 64-71 are not radially aligned with the plurality of pole members 17 on first portion 15. The number of fan blades 64-71 is also distinct from the number of pole members 18 on second portion 16. Each fan blade 64-71 includes a first end portion 77 that extends to a second end portion 78 (shown on fan blade 64). First end portion 77 includes a substantially planar surface 80, and second end portion 78 includes an angled region 82. Angled region 82 is angled relative to substantially planar surface 80. With this arrangement, the rotation of fan member 50 creates an air flow that is passed through housing 4.

Fan member 50 includes a plurality of mounting elements that take the form of openings 85-87 formed in substantially planar surface 80. In the exemplary embodiment shown, mounting openings 85-87 are substantially coplanar with substantially coplanar surface 80. Substantially coplanar should be understood to mean that there are no raised areas formed on substantially coplanar surface 80 about openings 85-87. In addition, mounting elements 85-87 are free from any raised regions on substantially planar surface 80. In this manner, fan member 50 contributes to an overall shorter axial dimension for electric machine 2. Mounting elements 85-87 are configured to cooperate with mounting members 23-25 to position fan member 50 upon rotor 10. As previously mentioned, the number of fan blades 64-71 is distinct from the number of pole members 17 on the first portion 15. That is, fan member 50 is positioned upon first portion 15 such that mounting members 23-25 register with and extend into mounting elements 85-87. Once in position, mounting members 23-25 are staked to create a mechanical connection between first portion 15 and fan member 50. In this manner, when rotor 10 rotates relative to stator 6, fan member 50 also rotates creating the cooling airflow. In further accordance with the exemplary embodiment, when fan member 50 is positioned upon first portion 15, a gap 94 is created between hub portion 60 and central hub 20. Gap 94 establishes a moat that traps any varnish that might be present on rotor 10. That is, gap 94 inhibits varnish from migrating into central hub 20 or along shaft 30 which could create a loose fit at bearing 42 or at pulley 44.

At this point it should be apparent that by minimizing the number of connections between the fan member and the rotor, and by eliminating raised portions about the connection zones, the rotor assembly has a shorter axial dimension. The shorter axial dimension that enables electric machine 2 to be formed having a more compact form factor. With a more compact form factor, varnish migration along the shaft can be a concern. However, by creating a gap between the rotor and the fan, varnish is trapped at the hub and thus does not migrate along the rotor shaft either toward the rotor or toward the pulley. In this manner, the gap ensures a prolonged operational life for the electric machine.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a rotor including a body having a number of pole members and a central hub, the rotor including a plurality of mounting members, the plurality of mounting members being fewer than half the number of pole members; and
a fan member mounted to the rotor, the fan member including a hub portion and a number of fan blades that project outwardly from the hub portion, the fan member including a plurality of mounting elements provided on select ones of the number of fan blades, wherein the plurality of mounting members engage respective ones of the plurality of mounting elements to attach the fan member to the rotor.

2. The electric machine according to claim 1, further comprising: a gap arranged between the hub portion and the central hub when the plurality of mounting members are engaged with the plurality of mounting elements.

3. The electric machine according to claim 1, wherein the plurality of mounting elements comprise openings formed in the select ones of the number of fan blades.

4. The electric machine according to claim 3, wherein the select ones of the number of fan blades is fewer than the number of fan blades.

5. The electric machine according to claim 3, wherein the plurality of mounting members comprise projections that extend out from the body and through the openings formed in the select ones of the number of fan blades.

6. The electric machine according to claim 5, wherein the projections extend outward from the body between adjacent ones of the number of pole members.

7. The electric machine according to claim 1, wherein each of the plurality of fan blades includes first end portion and a second end portion, the first end portion defining a substantially planar surface and the second end portion being angled relative to the substantially planar surface.

8. The electric machine according to claim 7, wherein the mounting elements are formed in the substantially planar portion of the select ones of the number of fan blades.

9. The electric machine according to claim 1, wherein the number of fan blades is distinct from the number of half the pole members.

10. The electric machine according to claim 9, wherein the number of fan blades is greater than the half the number of the pole members.

11. An electric machine comprising:
a rotor including a body having a number of pole members and a central hub, the rotor including a plurality of mounting members; and
a fan member mounted to the rotor, the fan member including a hub portion and a number of fan blades that project outwardly from the hub portion, the fan member including a plurality of mounting elements provided on select ones of the number of fan blades, the number of fan blades including a first end portion and a second end portion, the first end portion defining a substantially planar surface and the second end portion being angled relative to the substantially planar surface, the plurality of mounting elements being formed in and are substantially coplanar with the substantially planar portion of the select ones of the number of fan blades, wherein the plurality of mounting members engage respective ones of the plurality of mounting elements to attach the fan member to the rotor.

12. The electric machine according to claim 11, wherein the plurality of mounting elements comprise openings formed in the select ones of the number of fan blades.

13. The electric machine according to claim 12, wherein the select ones of the number of fan blades is fewer than the number of fan blades.

14. The electric machine according to claim 12, wherein the plurality of mounting members comprise projections that extend out from the body and through the openings formed in the select ones of the number of fan blades.

15. The electric machine according to claim 14, wherein the projections extend outward from the body between adjacent ones of the number of pole members.

16. The electric machine according to claim 11, further comprising: a gap arranged between the hub portion and the central hub when the plurality of mounting members are engaged with the plurality of mounting elements.

17. A method of securing a fan member having a number of fan blades to a rotor of an electric machine, the rotor including a number of poles, the number of poles being distinct from the number of fan blades, the method comprising:
positioning the fan member adjacent the rotor;
aligning a plurality of mounting members provided on the rotor with a corresponding plurality of mounting elements provided on the fan member, the plurality of mounting members being fewer than the number of poles; and
securing the plurality of mounting members directly to substantially planar portions of the number of fan blades at the plurality of mounting elements.

18. The method of claim 17, wherein positioning the fan member adjacent the rotor includes aligning a hub portion of the fan member with a central hub of the rotor.

19. The method of claim 18, further comprising: establishing a gap between the hub portion and the central hub.

20. The method of claim 17, wherein securing the plurality of mounting members directly to substantially planar portions of the number of fan blades includes:
passing the plurality of mounting members through respective ones of the plurality of mounting elements; and
staking the plurality of mounting members.
